(19) United States
(12) Patent Application Publication
(10) Pub. No.: US 2007/0291681 A1
(43) Pub. Date: Dec. 20, 2007

(54) Method and apparatus for providing information about each group address that has data waiting for delivery in node, point or terminal in a WLAN

(75) Inventors: Jari Jokela, Ylojarvi (FI); Jarkko Kneckt, Espoo (FI); Jani Poikela, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/603,283

(22) Filed: Nov. 20, 2006

Related U.S. Application Data
(60) Provisional application No. 60/814,142, filed on Jun. 16, 2006.

(51) Int. Cl. H04Q 7/00

(52) U.S. Cl. 370/328

(57) ABSTRACT

A method and apparatus are provided for communicating data between two nodes, points or terminals in a wireless local area network (WLAN) and providing information about each group address that has data waiting for delivery in one node, point or terminal. The two nodes, points or terminals may include an access point (AP) or other suitable network node, point or terminal, and a station (STA) or other suitable network node, point or terminal in the WLAN. The information about each group address may form part of an information element in a beacon provided from an access point to one or more nodes, points or terminals in the WLAN.

### CROSS-REFERENCE TO RELATED APPLICATIONS

This application claims benefit to provisional patent application Ser. No. 60/814,142, filed on 16 Jun. 2006, which is hereby incorporated by reference in its entirety.

### BACKGROUND OF THE INVENTION

1. Field of Invention

The present invention related to a method and apparatus for providing multicast service optimisations in wireless local area network (WLAN), including that set forth in IEEE 802.11; and more particularly, a method and apparatus for providing information about each group address that has data waiting for delivery in one node, point or terminal in such a WLAN.

2. Description of Related Art

The problem with the current broadcast and multicast service schemes in IEEE 802.11 networks is related to power save functionality. The base standard defines fixed power save scheme to be used by broadcast and different multicast services. The scheme basically defines a fixed listen interval for the non-AP STAs. The AP will buffer all the broadcast and multicast traffic and after specific DTIM Beacon frame (DTIM is every nth Beacon frame) it will deliver automatically all the buffered broadcast and multicast traffic. The problem here is that different broadcast and multicast services may have very different service characteristic and having only one static scheme in WLAN level is not flexible enough. The services may vary from very basic IP level broadcast services like Address Resolution Protocol (ARP) or Dynamic Host Configuration Protocol (DHCP), which typically have low bit rates with relaxed delay requirements, to different multicast streaming services (audio, video, . . . ) having high bit rate requirements and more strict real time requirements.

In effect, with WLAN multicast service enhancement, there can be different services: others like ARP are creating IP connectivity for the terminal. These protocols are running in the background all the time. When the terminal is inactive, in stand by state, the power consumption to receive data from these protocols defines the stand by power consumption. These protocols require long multicast/broadcast listen intervals, in order to reduce activity periods and power consumption. Some applications, like audio and video services, need short multicast listening intervals in order to meet QoS and delay requirements.

Currently, the AP can indicate that there is buffered broadcast or multicast data with the same single bit (known herein as the “AID 0” field). This causes the terminals to listen to the multicast data even though they would not be receiving any themselves.

There is a need for a better way to indicate that there is buffered broadcast or multicast data for delivery in a node, point or terminal in such a WLAN.

### SUMMARY OF THE INVENTION

In its broadest sense, the present invention provides a new and unique method and apparatus for communicating data between two nodes, points or terminals in a wireless local area network (WLAN) and providing information about each group address that has data waiting for delivery in one node, point or terminal. In particular, the method and apparatus shown and described herein is an improvement to techniques set forth in the aforementioned provisional patent applications, including in particular Ser. Nos. 60/733,999 (944-4.59/NC46867US) and 60/733,739 (944-4.60/NC46868US).

The two nodes, points or terminals may include an access point (AP) or other suitable network node, point or terminal, and a station (STA) or other suitable network node, point or terminal in the WLAN.

The information about each group address may form part of an information element in a beacon provided from an access point to one or more nodes, points or terminals in the WLAN.

The information about each group address may also forms part of an information element in one or more fields in a broadcast or multicast management frame, including a request/response type of management frame, provided from an access point to one or more nodes, points or terminals in the WLAN. In particular, the one or more fields may contain information about an element identification (ID), a length, a service parameter, one or more group addresses, or some combination thereof. The length field may be set to 2+n*6, where n indicates the number of group address fields. The service parameter field may include a legacy existence field that is set to indicate that stations (STAs) that are not supporting flexible multicast service intervals are currently associated in a basic service set (BSS). The one or more group address fields may indicate the group address for which an access point (AP) has one or more buffered frames.

The method may further comprise receiving and processing the information about each group address at the station or other suitable node, point or terminal and based on the content of the information deciding whether the station or other suitable node, point or terminal is having buffered broadcast and/or multicast frames in the AP.

The method further includes implementing the step thereof via a computer program running in a processor, controller or other suitable module in one or more nodes, points, terminals or elements in the WLAN.

The apparatus may take the form of a wireless local area network (WLAN) featuring two nodes, points or terminals, each configured for communicating data in the WLAN; and one node, point or terminal configured for providing information about each group address that has data waiting for delivery in the one node, point or terminal.

The apparatus may take the form of a node, point or terminal featuring a module configured for providing data to another node, point or terminal in a wireless local area network (WLAN) and another module configured for providing information about each group address that has data waiting for delivery in the node, point or terminal; as well as a node, point or terminal featuring a module configured for receiving data from another node, point or terminal in a wireless local area network (WLAN) and another module configured for receiving information about each group address that has data waiting for delivery in the other node, point or terminal.

The apparatus may take the form of a computer program product with a program code, which program code is stored on a machine readable carrier, for carrying out the steps of a method comprising communicating data between two nodes, points or terminals in a wireless local area network (WLAN) and providing information about each group address that has data waiting for delivery in one node, point or terminal, when the computer program is run in a module of a node, point or terminal, such as an Access Point (AP).

In effect, the present invention provides an improvement in the form of a new field “AID 0 Info” information element sent in beacons from the access point (AP) to the nodes, points or terminals. The use for the field is basically the AP telling the nodes, points or terminals if they have data waiting for delivery in the AP. This is already possible to indicate to the terminals using an existing bit for “AID 0” in the TIM field in the beacon, which has the length of 1 bit. By changing the bit on/off, the terminals will in the conventional method know whether they expect to receive data or not.

The present invention is more advanced from the conventional “AID 0” field and co-exists in the beacons with the conventional “AID 0” field. The basic idea is to enable telling each group address, whether they have data waiting for delivery in the access point. The use of the “End Of the Service Period” EOSP field is group address specific field, which indicates does the multicast or broadcast address have more data to deliver. The “More Data” bit indicates the presence of any buffered multicast or broadcast frames in delivery. Thus, the enhanced terminals may control the received multicast or broadcast frames in more fine grained logic and the “More Data” bit indicates the status of all groups.

The AP may transmit the multicast and broadcast frames in specific order, for instance transmitting first all frames from the lowest group address value. The lowest group address value can be interpret by handling the group address as unsigned integer value. After all frames from the lowest address have been transmitted, all frames from the second lowest are transmitted until the last transmitted frames are transmitted from the highest address value. Other examples of specific transmission order could be to transmit frames starting from the highest address value or by transmitting the multicast frames in the same order as specified in beacon, AID Info element and having the broadcast frames as first or last transmitted frames.

By applying a specific transmission order, the enhanced terminal knows whether the AP has already transmitted the frames from a specific group address. Thus, the order information creates more robustness for enhanced multicast capable terminals frames delivery, because the terminals may interpret the EOSP bit information from the group address value.

### BRIEF DESCRIPTION OF THE DRAWING

The drawing includes the following Figures, which are not necessarily drawn to scale:

FIG. 1 shows an IEEE 802.11 WLAN system according to some embodiments of the present invention.

FIG. 2 shows a flowchart of the basic steps of the method according to some embodiments of the present invention.

FIG. 3 shows an access point (AP) according to some embodiments of the present invention.

FIG. 4 shows a station (STA) according to some embodiments of the present invention.

FIG. 5 shows a AID 0 information element according to some embodiments of the present invention.

FIG. 6 shows a service parameter that forms part of the multicast service info information element shown in FIG. 5 according to some embodiments of the present invention.

FIGS. 7a and 7b show diagrams of the Universal Mobile Telecommunications System (UMTS) packet network architecture, which is also known in the art.

### BEST MODE OF THE INVENTION

FIG. 1 shows, by way of example, an IEEE 802.11 WLAN system generally indicated as 10 according to the present invention, which provides for communications between communications equipment such as mobile and secondary devices including personal digital assistants (PDAs), laptops and printers, etc., as shown The WLAN system 10 may be connected to a wired LAN system that allows wireless devices to access information and files on a file server or other suitable device, such as 12, or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

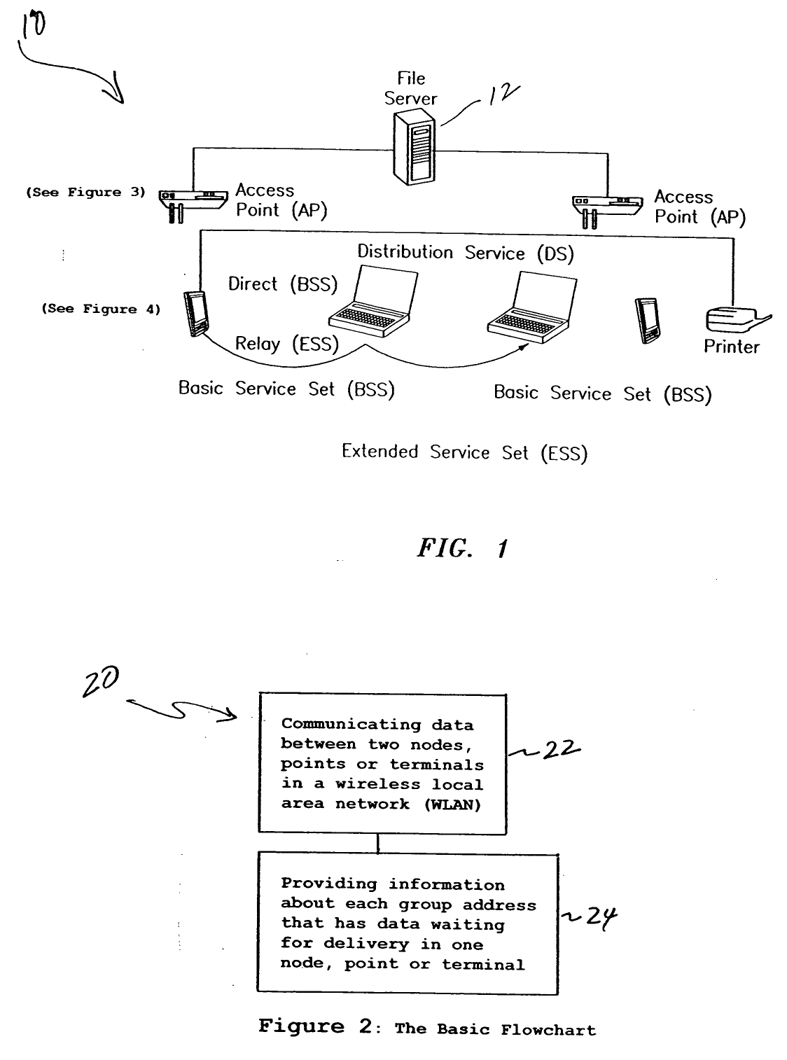

The present invention provides a new and unique technique for communicating data between two such nodes, points or terminals in such a WLAN 10 and providing information about each group address that has data waiting for delivery in one such node, point or terminal. The technique includes a method having the basic steps 22 and 24 shown in a flowchart generally indicated as 20 in FIG. 2 according to the present invention.

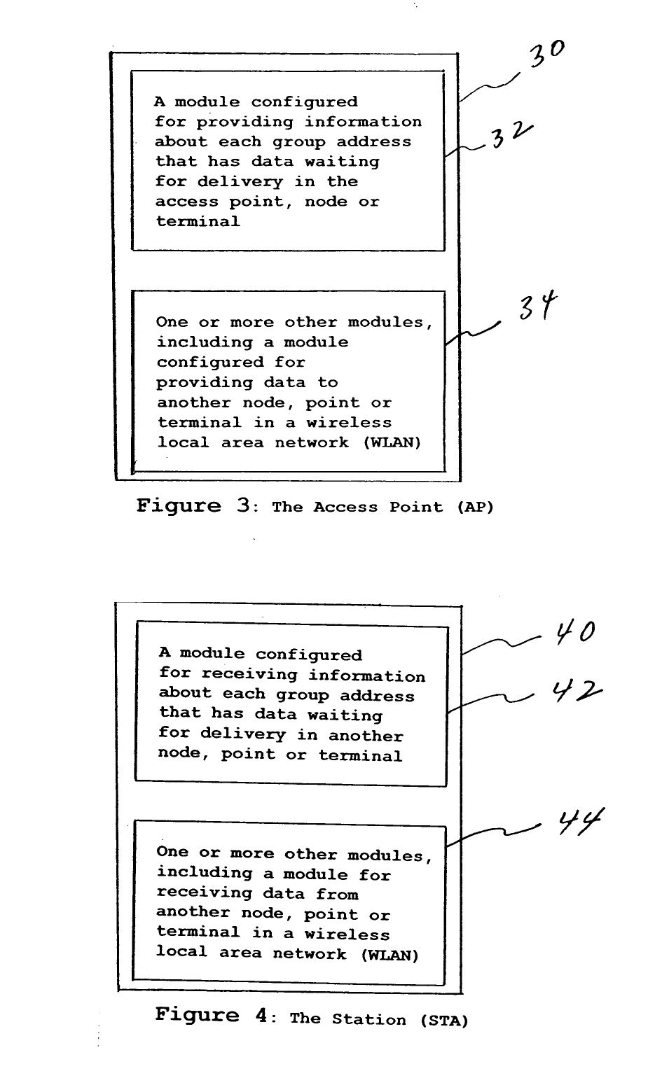

The two nodes, STAs, points or terminals in the WLAN may include an access point (AP) or other suitable network node or terminal 30 shown in FIG. 3 and a station (STA) or other suitable network node or terminal 40 shown in FIG. 4, for operating in such a wireless LAN network 10 consistent with that shown in FIG. 1. The AP 30 has a module 32 configured for providing information about each group address that has data waiting for delivery in one such node, point or terminal, while the STA 40 has a corresponding module 42 configured for receiving and processing the information about each group address at the station or other suitable node, point or terminal.

### The Basic Implementation

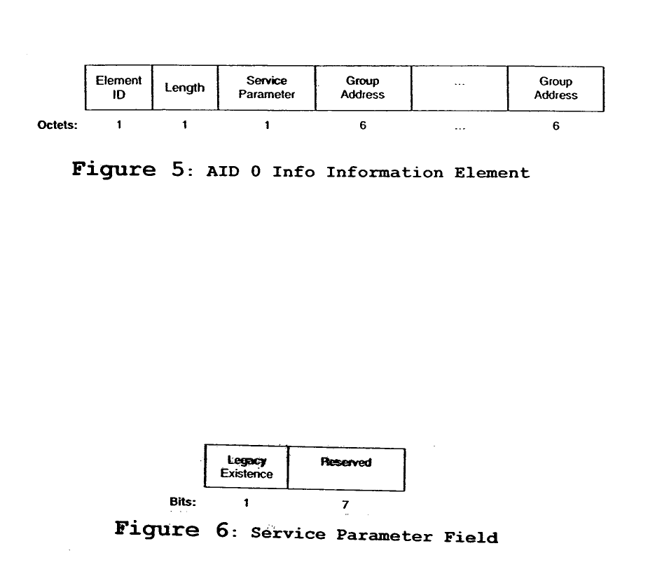

FIG. 5 shows a AID 0 info information element according to the present invention, which includes one or more fields that contain information about an element identification (ID), a length, a service parameter, one or more group addresses, or some combination thereof. The length field may be set to 2+n*6, where n indicates the number of group address fields. The one or more group address fields may indicate the group address for which an access point (AP) has one or more buffered frames.

FIG. 6 shows the service parameter that forms part of the AID 0 info information element shown in FIG. 5 according to the present invention. The service parameter field may include a legacy existence field that is set to indicate that stations (STAs) that are not supporting flexible multicast service intervals are currently associated in a basic service set (BSS).

By way of example, the basic implementation and cooperation of the AP 30 and STA 30 in relation thereto and according to the present invention is as follows:

The AID 0 Info gives information about the buffered broadcast or multicast frames. It is present only if the bit for AID 0 bit in the TIM field is set to 1.

The Length field shall be set to 2+n*6, where n indicates the number of Group Address fields.

The Service Parameter field is as shown in FIG. 6. The Legacy Existence field is set to 1 to indicate that STAs that are not supporting flexible multicast service intervals are currently associated in the BSS.

The Group Address fields indicate the group address for which the AP is having buffered frames.

### Implementation of the Functionality of the Modules

The functionality of the AP 30 and STA 30 described above may be implemented in the corresponding modules 32 and 42 shown in FIGS. 3 and 4. By way of example, and consistent with that described herein, the functionality of the modules 32 and 42 may be implemented using hardware, software, firmware, or a combination thereof, although the scope of the invention is not intended to be limited to any particular embodiment thereof. In a typical software implementation, the module 32 and 42 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 32 and 42 being a stand alone modules, as shown, or in the combination with other circuitry for implementing another module.

The other modules 34 and 44 and the functionality thereof are known in the art, do not form part of the underlying invention per se, and are not described in detail herein. For example, the other modules 34 may include other modules that formal part of a typical mobile telephone or terminal, such as a UMTS subscriber identity module (USIM) and mobile equipment (ME) module, which are known in the art and not described herein.

### 3GPP Network

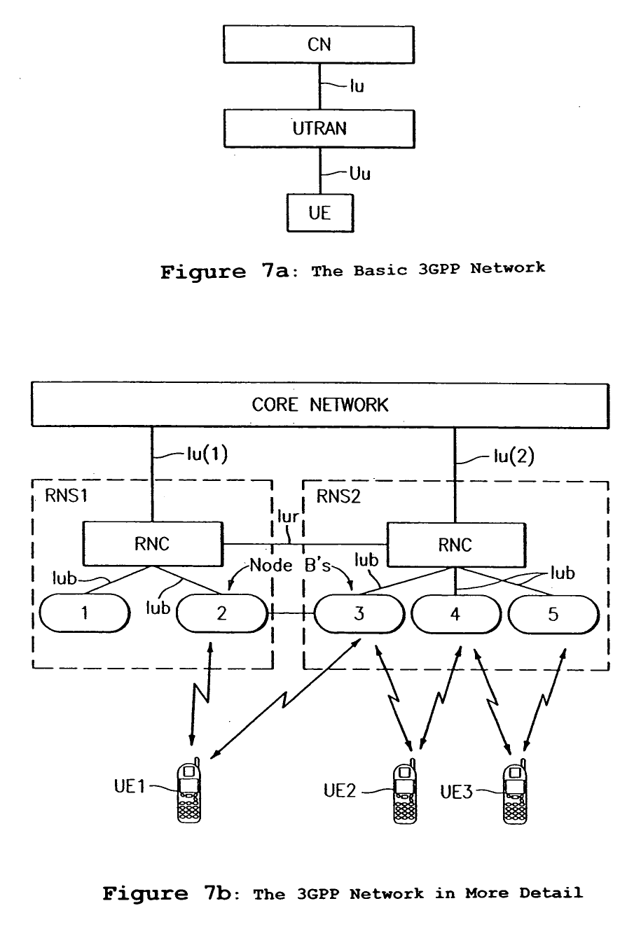

The interworking of the WLAN (IEEE 802.11) shown in FIG. 1 with such other technologies (e.g. 3GPP, 3GPP2 or 802.16) such as that shown in FIGS. 7a and 7b is being defined at present in protocol specifications for 3GPP and 3GPP2. The scope of the present invention is intended to include an implementation in relation to such an interworking.

By way of example, FIGS. 7a and 7b show diagrams of the Universal Mobile Telecommunications System (UMTS) packet network architecture, which is also known in the art. In FIG. 7a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 7a. A given UE may be in radio contact with multiple Node Bs even if one or more of the Node Bs are connected to different RNCs. For instance, a UE1 in FIG. 7b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 7a and 7b has resulted in STAs taking the form of UEs, such as mobile phones or mobile terminals.

### The Technique for Flexible Multicast Listening Intervals

The present invention may be used in conjunction with the technique for flexible multicast listening intervals consistent with that disclosed in provisional patent application Ser. No. 60/733,739 (944-4.60/NC46868US). The present invention allows flexible listen (sleeping) intervals for the multicast services (more optimal power save for the STAs) and separates broadcast and multicast services (e.g. different listen intervals and indications for buffered data). The AID 0 info broadcast gives information of the buffered broadcast and/or multicast frames in the AP.

In operation, the AP and the STA have possibilities to indicate its capability to support flexible multicast listen interval by using new fields either in Beacon and Probe Response frames or in (re)Association request frames. These new fields are described in the aforementioned related provisional patent application Ser. No. 60/733,999, filed 4 Nov. 2005, (identified by docket no. WFVA/Nokia Nos. 944-4.59/NC46867), which is hereby incorporated by reference in its entirety, which corresponds to one or more sections of IEEE 802.11 related to Wireless Network Management Capabilities.

An additional bit from the wireless Network Management Capabilities field can be used to indicate that the multicast and broadcast frames are delivered in a specific delivery order. The specific delivery order means that first all frames from the lowest mc or bc address are transmitted and the address value is increased until lastly the frames from the highest mc or bc address are delivered. There may be other embodiments for different delivery order policies. The strict delivery order can be used by the terminal to derive appropriate EOSP values for group addresses it is using.

The multicast service can be setup by using Multicast Service Setup signalling. During this signalling phase the listen interval for the multicast service can be agreed. The STA can propose a listen interval based on the multicast service characteristic and the AP can either accept the proposal or define a new listen interval. The same listen interval should be used for all terminals that receive the same multicast transmission. Multicast Service Setup is described in the aforementioned related provisional patent application Ser. No. 60/733,999.

By using AID 0 Info element the AP can indicate whether there are buffered broadcast data and/or buffered multicast traffic belonging to certain multicast group by using Group Address fields. AID 0 Info element. AID 0 Info element may be present only in those Beacon frames where the bit for the AID 0 in TIM field is set to 1.

The features of operation during power save modes are consistent with and forms part of one or more sections of IEEE P802.11, and are described as follows:

### Enhanced Multicast Power Management

With enhanced multicast service, it is possible to create flexible service intervals for multicast services.

A service interval for the multicast service is created by using the multicast service setup signaling. A non-AP STA wishing to join the multicast group can propose multicast listen interval to the AP. Multicast listen interval can be either multiple of Beacon periods or it can be specified in number of Time Units (TUs). Duration of TU is 1024 micro seconds. The AP will make the selection of the multicast listen interval and will indicate it in Multicast Service Setup Response frame, in Multicast Service Mode Change frame and in Beacon and Probe Response frames.

### AP Operation

If enhanced multicast service is used, the AP shall send a beacon with a complete Multicast Service Info field at every beacon.

Another embodiment of the invention would be to send a complete Multicast Service Info field at every DTIM beacon. At a TIM beacon, the AP shall transmit a Multicast Service Info element that contains information of Multicast services that transmit data after this TBTT. If the multicast data transmission is scheduled after the TBTT and the multicast address is not listed in Mulitcast Service Info, no data from the multicast address is transmitted after the TBTT. The Multicast Service Info element that is transmitted after TIM beacon TBTT shall not contain information of the multicast services that transmit data between TUs. A Buffered Traffic Indication bit shall be set if there are buffered frames belonging to particular multicast group.

If enhanced multicast service is used, the AP will send all multicast frames belonging to a particular multicast group after the service interval which is specified for the multicast service. The More Data field in MAC headers of each multicast frame shall be set to indicate the presence of further buffered multicast MSDUs from the multicast address. If the AP is unable to transmit all of the buffered multicast MSDUs before the next TBTT, the AP shall indicate that it will continue to deliver the multicast MSDUs by setting the Buffered Traffic Indication bit in Multicast Service Info field to 1. Buffered Traffic Indication bit shall be set to 1 until all buffered multicast frames have been transmitted.

### Receive Operation for Non-AP STAs in Power Save (PS) Mode

If enhanced multicast service is used, the non-AP STA shall wake up before the specified multicast listen interval. A non-AP STA shall remain awake until the More Data field of the multicast MSDU indicates there are no further buffered multicast MSDUs, or until Multicast Service is not listed in Multicast Service Info field or Buffered Traffic Indication field indicates that there are no further buffered multicast MSDUs.

Due to legacy compatibility reasons, broadcast and multicast traffic may need to be delivered the traditional way as well unless the AP is sure that all the associated STAs can use enhanced broadcast/multicast service. The STAs using enhanced broadcast/multicast service may need to take this into account in order to avoid duplicated frames.

### Alternative Technique for Flexible Multicast Service Interval

The present invention may also be used in conjunction with an alternative technique for flexible multicast service interval that is presently being considered in the Broadcast and Enhancements section of IEEE P802.11, which is summarized as follows:

An AP supporting flexible multicast intervals shall indicate its support by using Wireless Network Management Capability information element sent in the Association Response or Reassociation Response frames.

### An STA wishing to use flexible multicast service intervals shall indicate it by using Wireless Network Management Capability information element sent in the Association Request or Reassociation Request frames.

### Flexible Multicast Service Interval Operation

The non-AP STA that supports flexible multicast service intervals and is wishing to use flexible multicast service intervals shall complete a multicast service setup procedure for each multicast address for which it desires to receive frames. By completing this the non-AP STA can propose suitable listen interval for the requested multicast service. The AP can adopt the proposed service interval or use other service interval for the multicast service. Service interval can be either multiple beacon intervals or multiple of TUs. Optimally, the service intervals are selected such a way that the service interval is a multiple of DTIM intervals. If the AP denies the usage of flexible multicast service intervals, normal multicast transmission rules apply.

An AP uses the AID 0 Info field in Beacon frames to indicate to which broadcast or multicast addresses the buffered broadcast/multicast frames are targeted. This field is present only if the bit for AID 0 is set to 1.

The AP shall send all the broadcast and multicast data also normally if there are one or more associated STAs that do not support multicast enhancements or STAs that does support multicast enhancements but have not completed multicast service setup.

The non-AP STA may indicate that it is not using the flexible multicast service intervals anymore by transmitting a Multicast Service Termination Request frame. The AP shall respond upon receiving Multicast Service Termination Request by transmitting Multicast Service Termination Response frame to the non-AP STA.

### Flexible Multicast Service Interval Power Management

The following is a description of the flexible multicast service interval power management according to the present invention that are being proposed as part of the Broadcast and Multicast Enhancements sections of IEEE P802.11.

Using the flexible multicast service intervals makes it possible to create different service intervals for different multicast services.

The Service Interval for a multicast service is created by using the multicast service setup signaling. A non-AP STA wishing to join the multicast group can propose a multicast service interval to the AP. Multicast service interval can be either a multiple of Beacon periods or it can be specified in a number of TUs. The AP shall make the selection of the multicast service interval and shall indicate it by using the Multicast Service Setup Response frame.

The APs shall send an AID 0 Info element in each Beacon frame containing the bit for AID 0 set to 1. The AID 0 Info contains information about to which broadcast and/or multicast groups the buffered frames in the AP belongs to. Furthermore, it contains information whether all the associated STAs in the BSS are multicast enhanced or not.

If the non-AP STA is using flexible multicast service intervals, it may take into account that the AP shall send broadcast/multicast MSDUs using normal broadcast/multicast transmission rules if not all the associated STAs are capable of using flexible multicast service intervals. If there are associated legacy STAs that are not using flexible multicast service intervals the AP shall set Legacy Existence bit in AID 0 Info element to 1.

### AP Operation During the CP

If the flexible multicast service interval is used, the AP shall send the AID 0 Info field to every Beacon containing the bit for AID 0 set to 1. The AID 0 Info field shall indicate all the broadcast and/or multicast groups for which the AP is having buffered frames.

Moreover, if the flexible multicast service interval is used, the AP will send all multicast frames belonging to a particular multicast group immediately after the service interval which is specified for the multicast service. If all the associated STAs are using the flexible multicast service interval, then the “More Data” field of each multicast frame shall be set to indicate the presence of further buffered multicast MSDUs belonging to the multicast address of that particular frame. If all the associated STAs are broadcast/multicast enhanced, then the “More Data” field of each broadcast frame shall be set to indicate the presence of further buffered broadcast MSDUs. The AP shall indicate if there are associated STAs that do not support flexible multicast service intervals by setting Legacy Existence bit in the AID 0 Info element to 1. If all the associated STAs are not using the enhanced multicast service, then the “More Data” field of each multicast frame shall be set to indicate the presence of further buffered broadcast/multicast MSDUs. If the AP is unable to transmit all the buffered broadcast or multicast MSDUs before the next TBTT, then the AP shall indicate that it will continue to deliver the multicast MSDUs by setting the bit for AID 0 in the TIM field to 1 and by setting the AID 0 Info field to indicate to which group addresses there are still buffered frames. The AID 0 Info field shall be present until all buffered broadcast and multicast frames have been transmitted.

### Receive Operation for STAs in PS Mode During the CP

If the non-AP STA is using flexible multicast service intervals, it shall wake up before the specified multicast service interval. A non-AP STA shall remain awake until the “More Data” field of the multicast MSDU indicates there are no further buffered broadcast/multicast MSDUs or until AID 0 bit is set to 0 or until AID 0 Info element indicates that there are no further buffered multicast frames belonging to multicast groups of which the STA is using at the moment.

### Wireless Network Management Extensions

The following Table includes the wireless network management extensions:

| Item | Protocol Capability | References | Status | Support |
|---|---|---|---|---|
| RME8 | Flexible Multicast Service Intervals | 8.2.7.1 | CFv:O | Yes, No, N/A |
| RME8.2 | Multicast Service Setup Request frame | 7.4.6.5 | [CF2εRME8]:M | Yes, No, N/A |
| RME8.3 | Multicast Service Setup Response frame | 7.4.6.6 | [CF1εRME8]:M | Yes, No, N/A |
| RME8.4 | Multicast Service Termination Request frame | 7.4.6.7 | [CF2εRME8]:M | Yes, No, N/A |
| RME8.5 | Multicast Service Termination Response frame | 7.4.6.8 | [CF1εRME8]:M | Yes, No, N/A |

### Alternative Implementations

Alternative implementation options are:
Multicast Service Info could be sent also in separate frame. By this way the overhead in Beacons is reduced. On the other hand this may not be good from the e.g., roaming STAs point of view. Also from the power save point of view it is good that this info appears with known interval so that the STA can optimise it sleeping cycles accordingly.
Instead of using full multicast MAC addresses in the signalling phase, a compressed format can be used.
As described in invention AP may set the complete Multicast Service Info element to all beacons.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

What we claim is:

1. A method comprising:
communicating data between two nodes, points or terminals in a wireless local area network (WLAN); and
providing information about each group address that has data waiting for delivery in one node, point or terminal.

2. A method according to claim 1, wherein the two nodes, points or terminals include an access point (AP) or other suitable network node, point or terminal and a station (STA) or other suitable network node, point or terminal in the WLAN.

3. A method according to claim 1, wherein the information about each group address forms part of an information element in a beacon provided from an access point to one or more nodes, points or terminals in the WLAN.

4. A method according to claim 1, wherein the information about each group address forms part of an information element in one or more fields in a management frame, including a request/response type of management frame, provided from an access point to one or more nodes, points or terminals in the WLAN.

5. A method according to claim 4, wherein the one or more fields contains information about an element identification (ID), a length, a service parameter, one or more group addresses, or some combination thereof.

6. A method according to claim 4, wherein the length field is set to 2+n*6, where n indicates the number of group address fields.

7. A method according to claim 4, wherein the service parameter field includes a legacy existence field that is set to indicate that stations (STAs) that are not supporting flexible multicast service intervals are currently associated in a basic service set (BSS).

8. A method according to claim 4, wherein the one or more group address fields indicate the group address for which an access point (AP) has one or more buffered frames.

9. A method according to claim 4, wherein the management frame includes a broadcast or multicast frame.

10. A method according to claim 1, wherein the method further comprises receiving and processing the information about each group address.

11. A wireless local area network (WLAN) comprising:
two nodes, points or terminals, each configured for communicating data in the WLAN; and
one node, point or terminal configured for providing information about each group address that has data waiting for delivery in the one node, point or terminal.

12. A wireless local area network (WLAN) according to claim 11, wherein the two nodes, points or terminals include an access point (AP) or other suitable network node, point or terminal and a station (STA) or other suitable network node, point or terminal in the WLAN.

13. A wireless local area network (WLAN) according to claim 11, wherein the information about each group address forms part of an information element in a beacon provided from an access point to one or more nodes, points or terminals in the WLAN.

14. A wireless local area network (WLAN) according to claim 11, wherein the information about each group address forms part of an information element in one or more fields in a management frame, including a request/response type of management frame, provided from an access point to one or more nodes, points or terminals in the WLAN.

15. A wireless local area network (WLAN) according to claim 14, wherein the one or more fields contain information about an element identification (ID), a length, a service parameter, one or more group addresses, or some combination thereof.

16. A wireless local area network (WLAN) according to claim 14, wherein the length field is set to 2+n*6, where n indicates the number of group address fields.

17. A wireless local area network (WLAN) according to claim 14, wherein the service parameter field includes a legacy existence field that is set to indicate that stations (STAs) that are not supporting flexible multicast service intervals are currently associated in a basic service set (BSS).

18. A wireless local area network (WLAN) according to claim 14, wherein the one or more group address fields indicate the group address for which an access point (AP) has one or more buffered frames.

19. A wireless local area network (WLAN) according to claim 14, wherein the management frame includes a broadcast or multicast frame.

20. A wireless local area network (WLAN) according to claim 11, wherein one of the two nodes, points or terminals has a module for receiving and processing the information about each group address.

21. A node, point or terminal comprising:
a module configured for providing data to another node, point or terminal in a wireless local area network (WLAN); and
another module configured for providing information about each group address that has data waiting for delivery in the node, point or terminal.

22. A node, point or terminal according to claim 20, wherein the node, point or terminal is an access point (AP) or other suitable network node, point or terminal, and the one or more other nodes, points or terminals includes a station (STA) or other suitable network node, point or terminal in the WLAN.

23. A node, point or terminal according to claim 20, wherein the information about each group address forms part of an information element in a beacon provided from an access point to one or more nodes, points or terminals in the WLAN.

24. A node, point or terminal according to claim 20, wherein the information about each group address forms part of an information element in one or more fields in a management frame, including a request/response type of management frame, provided from an access point to one or more nodes, points or terminals in the WLAN.

25. A node, point or terminal according to claim 23, wherein the one or more fields contain information about an element identification (ID), a length, a service parameter, one or more group addresses, or some combination thereof.

26. A node, point or terminal according to claim 23, wherein the length field is set to 2+n*6, where n indicates the number of group address fields.

27. A node, point or terminal according to claim 23, wherein the service parameter field includes a legacy existence field that is set to indicate that stations (STAs) that are not supporting flexible multicast service intervals are currently associated in a basic service set (BSS).

28. A node, point or terminal according to claim 23, wherein the one or more group address fields indicate the group address for which an access point (AP) has one or more buffered frames.

29. A node, point or terminal according to claim 23, wherein the management frame includes a broadcast or multicast frame.

30. A node, point or terminal comprising:
a module configured for receiving data from another node, point or terminal in a wireless local area network (WLAN); and
another module configured for receiving information about each group address that has data waiting for delivery in the other node, point or terminal.

31. A node, point or terminal according to claim 29, wherein the node, point or terminal is a station (STA) or other suitable network node, point or terminal in the WLAN, and the one or more other nodes, points or terminals includes an access point (AP) or other suitable network node, point or terminal.

32. A node, point or terminal according to claim 29, wherein the information about each group address forms part of an information element in a beacon provided from an access point to one or more nodes, points or terminals in the WLAN.

33. A node, point or terminal according to claim 29, wherein the information about each group address forms part of an information element in one or more fields in a management frame, including a request/response type of management frame, provided from an access point to one or more nodes, points or terminals in the WLAN.

34. A node, point or terminal according to claim 32, wherein the one or more fields contain information about an element identification (ID), a length, a service parameter, one or more group addresses, or some combination thereof.

35. A node, point or terminal according to claim 32, wherein the length field is set to 2+n*6, where n indicates the number of group address fields.

36. A node, point or terminal according to claim 32, wherein the service parameter field includes a legacy existence field that is set to indicate that stations (STAs) that are not supporting flexible multicast service intervals are currently associated in a basic service set (BSS).

37. A node, point or terminal according to claim 32, wherein the one or more group address fields indicate the group address for which an access point (AP) has one or more buffered frames.

38. A node, point or terminal according to claim 32, wherein the management frame includes a broadcast or multicast frame.

39. A computer program product with a program code, which program code is stored on a machine readable carrier, for carrying out the steps of a method comprising communicating data between two nodes, points or terminals in a wireless local area network (WLAN) and providing information about each group address that has data waiting for delivery in one node, point or terminal, when the computer program is run in a module of a node, point or terminal, such as an Access Point (AP).

40. A method according to claim 1, wherein the method further comprises implementing the step of the method via a computer program running in a processor, controller or other suitable module in one or more nodes, points, terminals or elements in the wireless LAN network.

41. Apparatus comprising:
means for communicating data between two nodes, points or terminals in a wireless local area network (WLAN); and
means for providing information about each group address that has data waiting for delivery in one node, point or terminal.

42. Apparatus according to claim 41, wherein the information about each group address forms part of an information element in a beacon provided from an access point to one or more nodes, points or terminals in the WLAN.

43. Apparatus according to claim 41, wherein the information about each group address forms part of an information element in one or more fields in a management frame, including a request/response type of management frame, provided from an access point to one or more nodes, points or terminals in the WLAN.

44. A method according to claim 3, wherein the group address information is present in the beacon only if the bit for AID 0 is set to 1 in the TIM field.

45. A wireless local area network (WLAN) according to claim 13, wherein the group address information is present in the beacon only if the bit for AID 0 is set to 1 in the TIM field.

46. A node, point or terminal according to claim 23, wherein the group address information is present in the beacon only if the bit for AID 0 is set to 1 in the TIM field.

47. A node, point or terminal according to claim 32, wherein the group address information is present in the beacon only if the bit for AID 0 is set to 1 in the TIM field.
